(19) United States
(12) Patent Application Publication
(10) Pub. No.: US 2012/0181730 A1
(43) Pub. Date: Jul. 19, 2012

(54) CUTTING TOOL AND METHOD

(75) Inventors: Martin Edwards, Bristol (GB); Risto Kallinen, Bristol (FI); Simon Topping, Bristol (GB)

(73) Assignee: AIRBUS OPERATIONS LIMITED, Bristol (GB)

(21) Appl. No.: 13/426,130

(22) Filed: Mar. 21, 2012

Related U.S. Application Data
(62) Division of application No. 12/415,202, filed on Mar. 31, 2009, now Pat. No. 7,905,479.

(30) Foreign Application Priority Data
Apr. 28, 2008 (GB) 0807639.0

(51) Int. Cl. B06B 1/10; B29C 67/00

(52) U.S. Cl. 264/442; 264/155

(57) ABSTRACT

A cutting tool has: a rotatable hollow tube with an inlet at a distal end of the tube and a cutting edge at the perimeter of the inlet, the tube being arranged so as to rotate when in use so as to cut a work piece with the cutting edge; and an auger housed within the hollow tube, the auger being arranged so as to rotate when in use so as to feed cut material from the inlet along the hollow tube, wherein a distal end of the auger is set back from the cutting edge of the tube.

### CROSS REFERENCE TO RELATED APPLICATION

The present application is a divisional of U.S. application Ser. No. 12/415,202, filed Mar. 31, 2009 and is based on, and claims priority from, British Application Number 0807639.0, filed Apr. 28, 2008, the disclosure of which is hereby incorporated by reference herein in its entirety

### FIELD OF THE INVENTION

The present invention relates to a cutting tool, a method of drilling a hole in a dry fibre assembly, and a method of manufacturing a composite component.

### BACKGROUND OF THE INVENTION

To manufacture composite materials using infusion processes such as Resin Transfer Moulding®, it may be necessary to cut tight tolerance holes in the dry fibre lay-up prior to infusion to locate the lay-up to the cure or infusion tooling and/or keep the dry fibre assembly in place during the forming operation. A wide variety of different cutting methods can be considered for this purpose, such as Numerically Controlled (NC) ultrasonic ply cutting, water jet and laser cutting, conventional or NC-drilling, pressing or punching and orbital drilling. However, none of these techniques are suitable for cutting accurate holes in thick dry fibre assemblies.

Conventional drills are prone to snagging on the fibres, which can damage the material and increase the expected tolerance in the size of the resultant holes. Moreover water jet cutters can contaminate the lay-up, while laser cutters often burn off the binder from the cutting area. Consequently, these devices are rarely used.

The most common method is to cut the holes manually with a knife. Although this can provide satisfactory results with relatively thin assemblies of dry fibre, this technique is not sufficiently accurate for thicker dry fibre assemblies. Likewise, punching or pressing may prove suitable with thin dry fibre assemblies. However, with thicker dry fibre assemblies, the cutting tool becomes prone to failure.

Disposing of the waste produced during the cutting process can also be a significant problem. With conventional drilling techniques, the cutting tools can quickly become clogged with waste material, preventing long term continuous drilling and making the process inefficient.

### SUMMARY OF THE INVENTION

A first aspect of the invention provides a cutting tool comprising: a rotatable hollow tube with an inlet at a distal end of the tube and a cutting edge at the perimeter of the inlet, the tube being arranged to rotate when in use so as to cut a work piece with the cutting edge; and an auger housed within the hollow tube, the auger being arranged to rotate when in use so as to feed cut material from the inlet along the hollow tube, wherein a distal end of the auger is set back from the cutting edge of the tube.

A further aspect of the invention provides a method of operating the tool of the first aspect of the invention, the method comprising rotating the hollow tube so as to cut a work piece with the cutting edge; and rotating the auger so as to feed cut material from the inlet along the hollow tube.

The hollow tube may further comprise an outlet for expelling the cut material. This outlet may be an axial hole at a proximal end of the tube, or more preferably an outlet hole in a side of the hollow tube. A vacuum pump may be coupled to the outlet so as to remove the cut material, optionally via a vacuum chamber which surrounds the hollow tube at an axial position aligned with the outlet hole.

The cutting edge may be circular or may comprise one or more teeth. Preferably the teeth have edges which deviate from a circular line transverse to the axis of the hollow tube by an angle no greater than 90°.

The hollow tube and the auger may be rotated in the same direction and at the same rate. In this case means may be provided (such as a set screw) for preventing relative rotation between the hollow tube and the auger. Alternatively the auger may be rotated at a higher rate and/or in a different direction to the hollow tube.

A further aspect of the invention provides a method of drilling a hole in a dry fibre assembly, the method comprising engaging the dry fibre assembly with a cutting tool comprising a hollow tube with an inlet at a distal end of the tube and a cutting edge at the perimeter of the inlet; and rotating the hollow tube so as to cut the dry fibre assembly with the cutting edge.

A further aspect of the invention provides a method of manufacturing a composite component comprising: engaging a fibre assembly with a cutting tool comprising a hollow tube with an inlet at a distal end of the tube and a cutting edge at the perimeter of the inlet; drilling a hole in the fibre assembly by rotating the hollow tube so as to cut the fibre assembly with the cutting edge; infusing the fibre assembly with a liquid matrix after the hole has been drilled; and curing the liquid matrix.

The cutting tool may comprise a tool according to the first aspect of the invention, or a more basic cutting tool with no auger.

Preferably the cutting tool comprises one or more teeth, and the teeth have edges which deviate from a circular line transverse to the axis of the hollow tube by an angle no greater than 90°.

A further aspect of the invention provides a cutting tool comprising: a rotatable hollow tube with an inlet at a distal end of the tube, a cutting edge at the perimeter of the inlet, the tube being arranged to rotate when in use so as to cut a work piece with the cutting edge, and an outlet for expelling the cut material; and a vacuum pump coupled to the outlet of the rotatable hollow tube.

A further aspect of the invention provides a method of operating the tool of the preceding aspect of the invention, the method comprising rotating the hollow tube so as to cut a work piece with the cutting edge; and operating the vacuum pump to remove the cut material from the outlet.

### BRIEF DESCRIPTION OF THE DRAWINGS

Embodiments of the invention will now be described with reference to the accompanying drawings, in which:

FIG. 1 is a schematic side view of a cylindrical cutting tool;

FIG. 2 is a perspective view of the cutting tool of FIG. 1 being aligned with a drill bush and pressure pad on an assembly of dry carbon fibres;

FIGS. 3 and 4 are sectional views of the cutting tool being used to cut a hole in the assembly of dry carbon fibres;

FIG. 5 shows an alternative cutting edge profile for the cutting tool;

FIG. 6 shows the cutting edge profile of FIG. 5 unrolled into a flat shape;

FIG. 7 is a schematic cross-sectional view of a cutting tool with an auger;

FIG. 8 is a perspective view of the tube used in the cutting tool of FIG. 7, with an alternative cutting edge profile; and

FIG. 9 is a perspective view of the auger used in the cutting tool of FIG. 7.

### DETAILED DESCRIPTION OF EMBODIMENT(S)

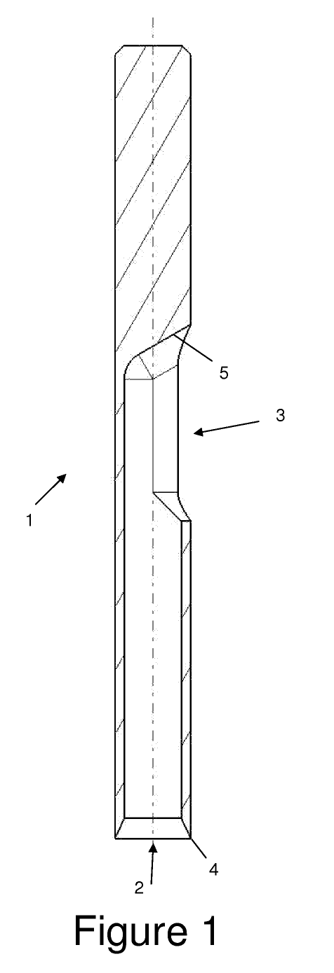

FIG. 1 shows a cutting tool 1. The bottom part of the tool is hollow with an inlet hole 2 at its distal end and an outlet hole 3 in the side of the tool. The tool is solid above the outlet hole 3 and is gripped by a drill (not shown) which rotates the tool 1 when in use. The cylindrical walls of the hollow part of the tool taper to a circular cutting edge 4.

The body of the cutting tool 4 is preferably formed from steel. The cutting edge 4 may be made from a hardened material such as tungsten carbide or diamond. Alternatively, the cutting edge 4 may be made from steel with a brazed-on hardened tip (for instance tungsten carbide).

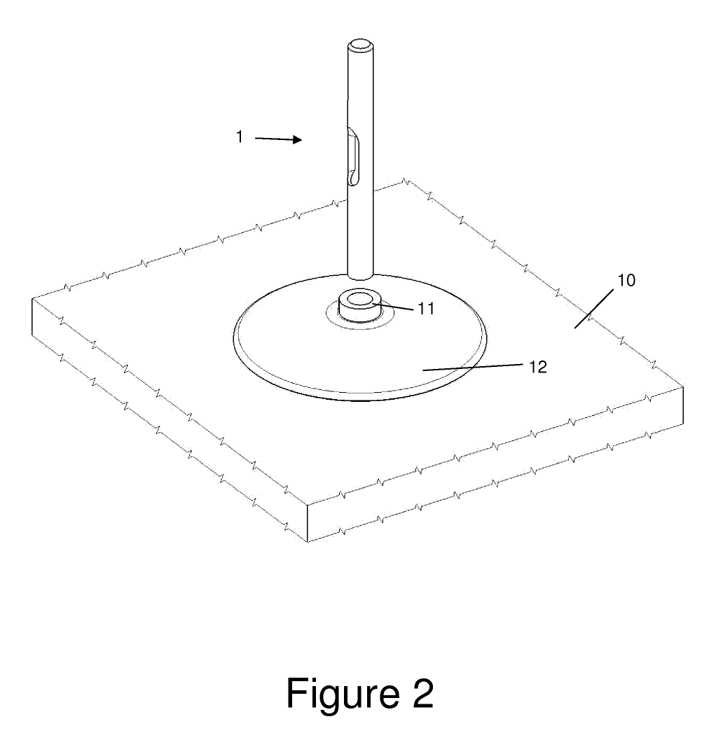

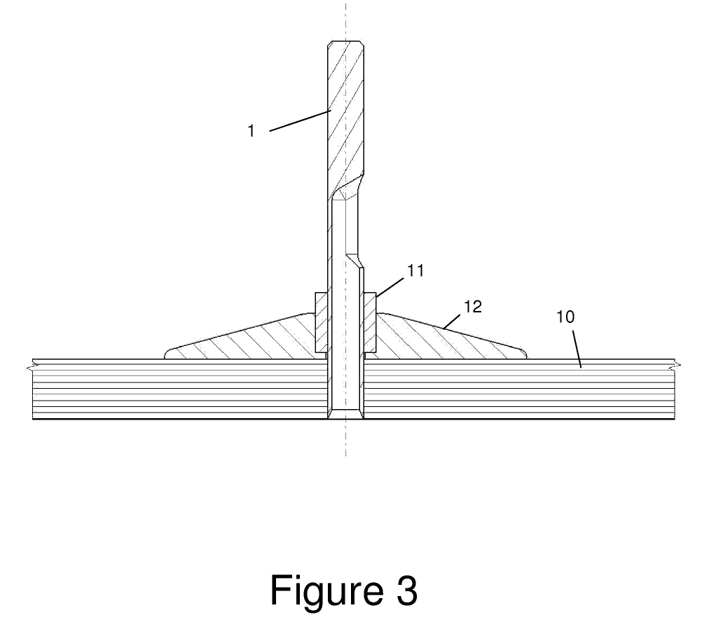

FIG. 2 show a dry fibre assembly 10 of dry carbon fibres with a layered structure shown in FIG. 3. The layers in the dry fibre assembly are bound together by heating and compressing the dry fibre assembly. This melts a binder material coating the fibres and binds the layers together. The dry fibre assembly 10 is a precursor in a so-called Resin Transfer Moulding® process described in further detail below, or any other type of infusion process.

A drill bush 11 is fitted into a pressure pad 12 and placed on the dry fibre assembly at a desired position as shown in FIG. 2. Then the tool 1 is inserted into the drill bush 11 until the cutting edge 4 engages the top of the dry fibre assembly 10. The tool 1 is rotated by the drill and pushed down so that the cutting edge progressively cuts through the dry fibre assembly as shown in FIG. 3. The pressure pad 12 minimises ply lifting during the cutting operation.

Cut material enters the inlet 2 and is ejected from the outlet 3, guided by an angled wall 5 shown in FIG. 1. This prevents the tool from becoming clogged and allows continuous operation of the drill without needing to pause and manually remove the cut material from the tool. Finally the tool is removed to leave a hole 13 shown in FIG. 4.

After the hole 13 has been cut, the dry fibre assembly 10 is infused with a liquid epoxy resin matrix. The infused dry fibre assembly is then heated to cure the epoxy resin. A locating member (not shown) is inserted into the hole 13 during the infusion process to keep the dry fibre assembly in place.

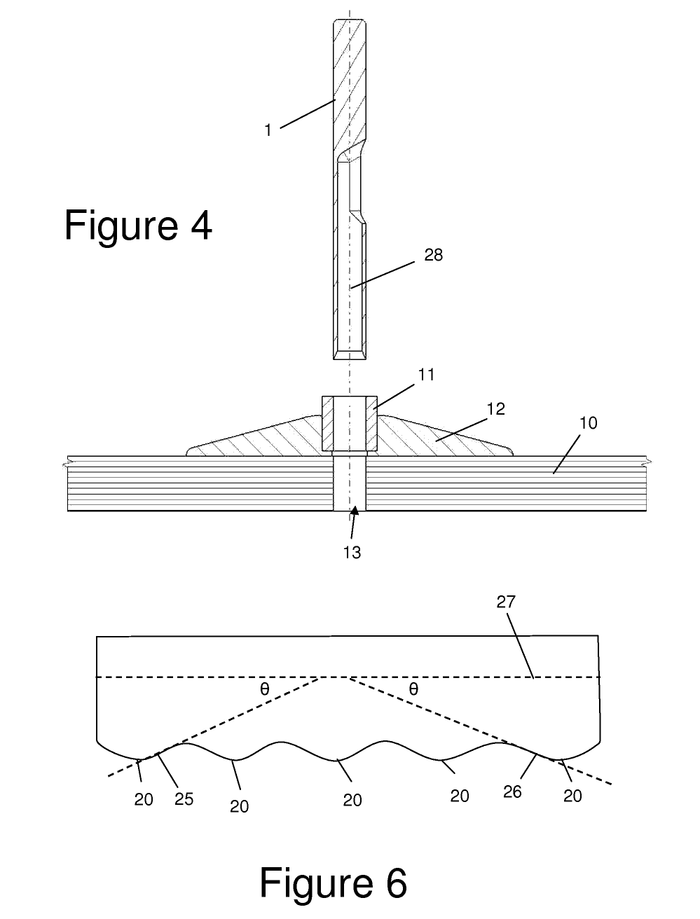

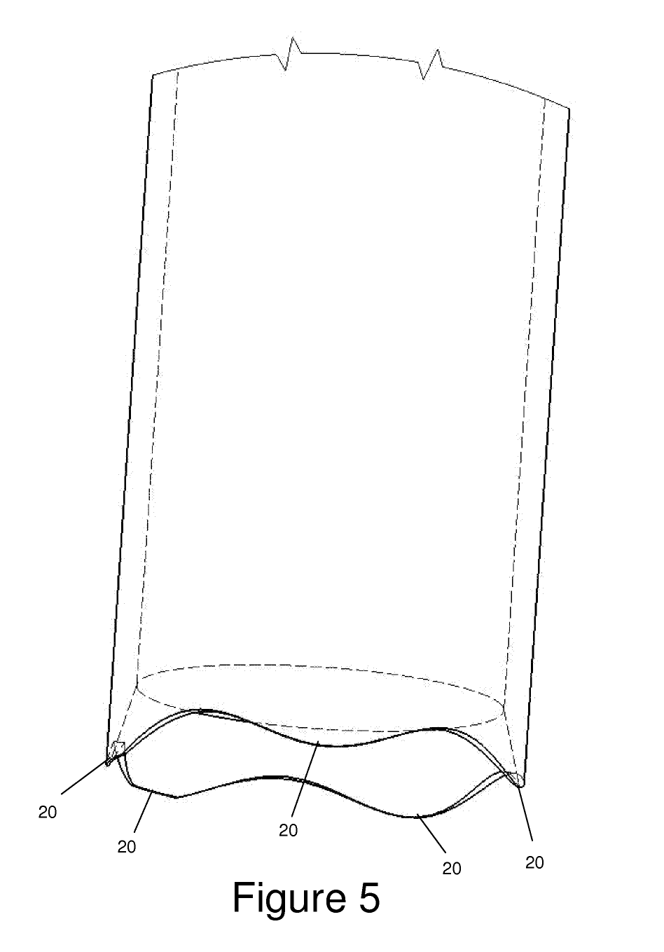

FIG. 5 shows an alternative shape for the cutting edge of the tool. In this case the cutting edge comprises a set of five teeth 20. FIG. 6 shows the shape of the teeth 20 more clearly. FIG. 6 is a view of the distal end of the hollow tube of FIG. 5 after being unrolled into a flat shape. The teeth 20 are gently and continuously curved with an approximately sinusoidal profile.

The tooth shape shown in FIG. 6 is preferred for drilling holes in the dry-fibre assembly 10 because the teeth 20 have no reverse-directed edges. In other words the teeth 20 have edges 25, 26 which deviate from a circular line 27 transverse to the axis 28 of the hollow tube by angles θ which are no greater than 90°.

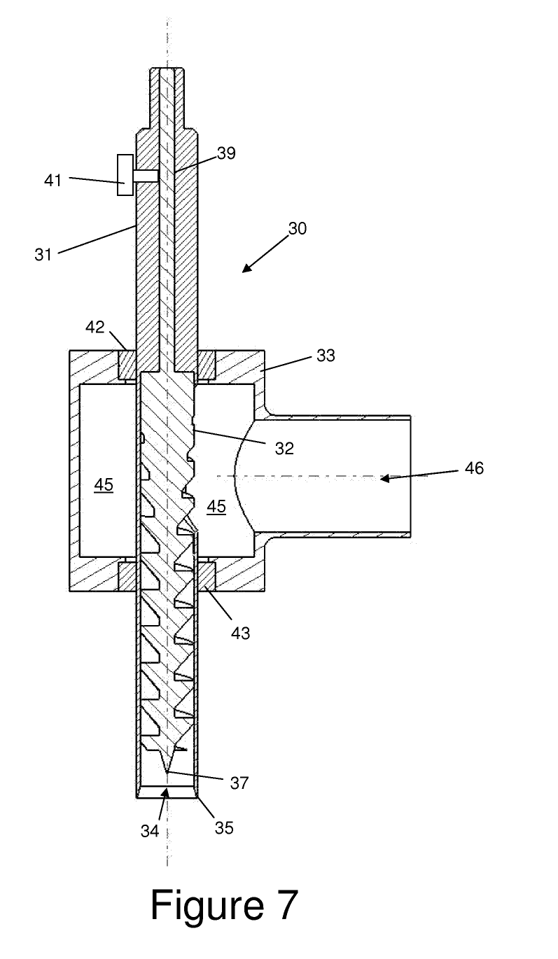

FIG. 7 illustrates an alternative cutting tool 30. The tool has three major components: a tube 31; an auger 32 housed within the tube 31; and a vacuum connector 33.

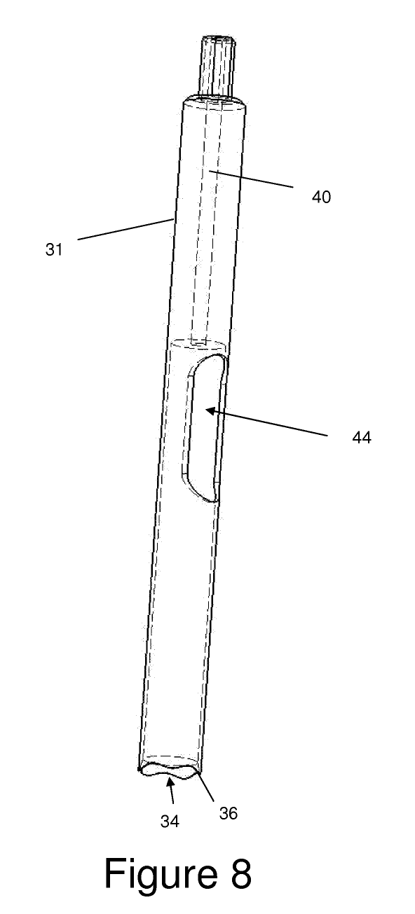

The bottom of the tube 31 is hollow with an inlet 34 at its distal end and a cutting edge 35 at the perimeter of the inlet. The cutting edge 35 shown in FIG. 7 is circular, but an alternative toothed cutting edge profile 36 is shown in FIG. 8. The profile of the cutting edge 36 is similar to the cutting edge profile shown in FIGS. 5 and 6.

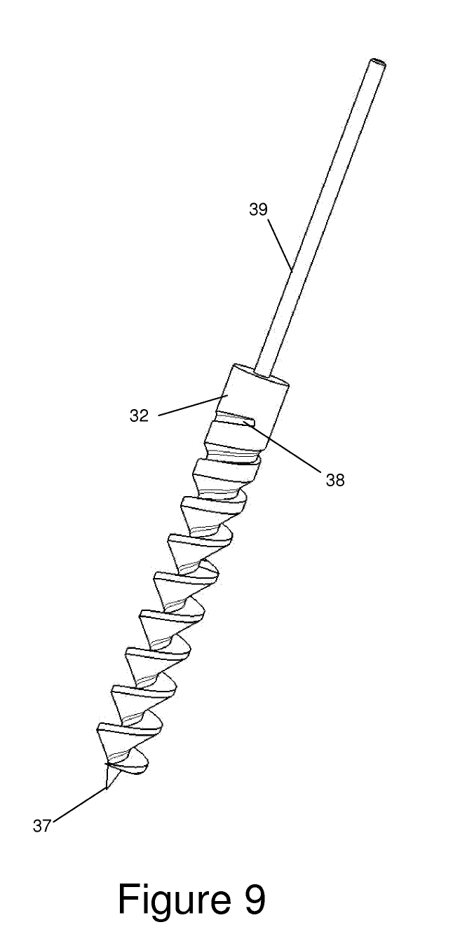

The auger 32 has a helical channel running from a sharp tip 37 at the distal end of the auger to an end 38 shown most clearly in FIG. 9. The auger has a shaft 39 which is fitted into a hole 40 in the tube 31. A set screw 41 (also known as a grub screw) passes through a threaded hole in the hollow tube and is tightened against the shaft 39 of the auger to prevent relative rotation between the tube and the auger. In an alternative arrangement (not shown) the coupling between the tube and the auger can be achieved through a direct connection between the auger and the body of the tube. Alternatively there may be no coupling between them, and relative rotation between the tube and the auger is prevented by gripping both the shaft 39 of the auger 15 and the tube 31 with the drill.

The vacuum connector 33 has a pair of sealed bearings 42, 43 which carry the tube 31 and enable the tube 31 and auger 32 to be rotated together whilst the vacuum connector 33 remains stationary.

The tube 31 has an outlet hole 44 in its side, shown most clearly in FIG. 8. The interior of the vacuum connector 33 defines a vacuum chamber 45 which surrounds the hollow tube at an axial position aligned with the outlet hole 44. The vacuum chamber 45 has a vacuum outlet 46 which can be coupled to a vacuum pump (not shown).

The tube 31 is gripped by a drill (not shown) which rotates the tube 31 and auger 32 together. The auger 32 feeds cut material from the inlet 34 along the hollow tube, out of the outlet hole 44 and into the vacuum chamber 45. The cut material is then sucked from the vacuum chamber through the vacuum outlet 46.

In an alternative embodiment (not shown) the auger may be rotated at a higher rate and/or in a different direction to the hollow tube. In this case the set screw 41 will be omitted. If the auger is rotated in a different direction to the hollow tube then the direction of the auger thread will be reversed so that the cut material is fed in the correct direction. A gear box (not shown) can be used to generate the desired rate and direction for the two components.

In an alternative embodiment (not shown) the auger 32 may be omitted, along with the hole 40 in the tube 31. In this case the cut material is fed from the inlet 34 of the hollow tube to the vacuum outlet 46 by the action of the vacuum only.

When bound dry fibre is drilled, the cut material expands in volume. This leads to the production of a large quantity of waste cut material. By employing an auger and/or a vacuum pump, this large quantity of waste material can be disposed of quickly and efficiently allowing the tool to be used continuously for long periods of time.

The tip 37 at the distal end of the auger 32 is set back from the cutting edge 35,36 of the tube. This prevents the auger from snagging and/or tearing the carbon fibres as they are cut.

Hole tolerances lower than +/−0.1 mm in diameter have been achieved in dry fibre lay-ups using the tools described in FIGS. 1-6.

To improve the tool further, the tools 10, 30 may be fitted with an ultrasonic head (not shown). Vibrations produced by the ultrasonic head assist in the cutting process, allowing the operator to exert less force to manufacture the required holes.

Although the invention has been described above with reference to one or more preferred embodiments, it will be appreciated that various changes or modifications may be made without departing from the scope of the invention as defined in the appended claims.

1. A method of manufacturing a composite component comprising:
a. engaging a fibre assembly with a cutting tool comprising a hollow tube with an inlet at a distal end of the tube and a cutting edge at the perimeter of the inlet;
b. drilling a hole in the fibre assembly by rotating the hollow tube so as to cut the dry fibre assembly with the cutting edge;
c. infusing the fibre assembly with a liquid matrix after the hole has been drilled; and
d. curing the liquid matrix.

2. A method according to claim 1, further comprising rotating an auger housed within the hollow tube with a distal end which is set back from the cutting edge of the tube so as to feed cut material from the inlet along the hollow tube.

3. A method according to claim 2, further comprising preventing relative rotation between the hollow tube and the auger.

4. A method according to claim 3, wherein relative rotation between the hollow tube and the auger is prevented using a set screw which passes through a threaded hole in the hollow tube and is tightened against the auger.

5. A method according to claim 2, wherein the auger is rotated at a higher rate and/or in a different direction to the hollow tube.

6. A method according to claim 2, wherein the auger has a helical channel.

7. A method according to claim 2, further comprising expelling the cut material through an outlet hole in a side of the hollow tube.

8. A method according to claim 2, further comprising using a vacuum to remove the cut material which has been fed by the auger from the inlet along the hollow tube.

9. A method according to claim 1, wherein drilling the hole generates cut material, and the method further comprising expelling cut material through an outlet of the hollow tube.

10. A method according to claim 9, wherein the outlet comprises an outlet hole in a side of the hollow tube.

11. A method according to claim 1, wherein the cutting tool comprises one or more teeth.

12. A method according to claim 11, wherein the teeth have edges which deviate from a circular line transverse to the axis of the hollow tube by an angle no greater than 90°.

13. A method according to claim 12, wherein the teeth are gently and continuously curved with an approximately sinusoidal profile.

14. A method according to claim 1, further comprising placing a pressure pad with a drill bush on the fibre assembly and inserting the cutting tool into the drill bush until the cutting edge engages the fibre assembly.

15. A method according to claim 1, further comprising inserting a locating member into the hole before infusing the fibre assembly with the liquid matrix.

16. A method according to claim 1, further comprising vibrating the cutting tool with an ultrasonic head to assist in the cutting process.

17. A method according to claim 1, wherein the liquid matrix is an epoxy resin.
